(19) United States
(12) Patent Application Publication
(10) Pub. No.: US 2007/0203827 A1
(43) Pub. Date: Aug. 30, 2007

(54) Method for enhancing revenue and minimizing charge-off loss for financial institutions

(75) Inventors: Steven D. Simpson, Austin, TX (US); Sam C. French, Austin, TX (US)

Correspondence Address: MEYERTONS, HOOD, KIVLIN, KOWERT & GOETZEL, P.C., P.O. BOX 398, AUSTIN, TX, 78767-0398, US

(73) Assignee: Sheshunoff Management Services, LP, Austin, TX (US)

(21) Appl. No.: 11/362,648

(22) Filed: Feb. 27, 2006

(51) Int. Cl. G06Q 40/00

(52) U.S. Cl. 705/38

(57) ABSTRACT

In one embodiment, a computer accessible medium stores a plurality of instructions which, when executed: (i) statistically analyze account data corresponding to a plurality of accounts at a financial institution to determine which account data items are most strongly correlated to a charge-off event in an account (and/or a fee revenue event, in some embodiments); (ii) generate one or more factors for one or more equations corresponding to the plurality of accounts, the one or more factors weighting the account data items according to relative correlation to the charge-off event; and (ii) evaluate the one or more equations for the plurality of accounts and establish an account feature for each of the plurality of accounts responsive to the evaluation. For example, the account feature may be the overdraft limit.

### BACKGROUND

1. Field of the Invention

This invention is related to software for financial institutions.

2. Description of the Related Art

Financial institutions are organizations which provide various account services for their customers, serving their customer's financial needs. Financial institutions may include banks, credit unions, savings and loan associations, lending institutions, etc. Financial institutions offer a variety of accounts and services, such as demand-deposit accounts (e.g. checking, savings, and money-market), time deposit accounts (e.g. certificates of deposit, or CDs), loans, etc.

Financial institutions earn profits from borrowing money at low rates (e.g. from depositors) and lending the money at higher rates. Additionally, financial institutions generate fee income for providing various services and/or account features. For example, a common feature offered by many banks on checking accounts is an overdraft privilege. The overdraft privilege permits the customer to overdraw the account, causing a negative balance. The institution pays the item that causes the overdraft, and may charge a fee. By permitting the customer to overdraw the account (e.g. by presenting a check for which there are not sufficient funds in the checking account to pay the check, referred to as an NSF check), the customer may avoid the extra fees and inconvenience incurred when the check is returned to the presenter. For example, the presenter (e.g. the entity to which the check is written) may charge additional fees or even file criminal charges against the customer if the check is returned.

If the customer overdrafts the account, a fee can be generated. The bank may inform the customer of the overdraft, and the customer may be expected to restore the balance to a positive or zero amount relatively quickly.

Features like the overdraft privilege, while generating fee income, also entail the risk that the customer will not or cannot restore the balance in the account. If the customer cannot restore the balance, the bank eventually cancels the debt. For example, federal regulations in the United States currently require a demand-deposit account that has a negative balance for 60 consecutive days to be converted to a loan. Accordingly, banks typically cancel the debt (“charge-off”) before the 60 day period to avoid the expense of creating loan documents and having the customer execute the loan. The bank experiences a loss when charging-off, reducing profits.

To control the risk and loss of profits that the overdraft privilege entails, banks typically set limits on the overdraft privilege (“overdraft limits”). The limits are often based on the amount of time that the account has been in existence (“open”), as well as the average collected balance on the account over preceding measurement periods such as months. However, for a given institution, it is not necessarily the case that the average collected balance of a given account is a good measure of the risk of providing a given amount of overdraft limit. Neither is the amount of time that the account has been open necessarily a good predictor.

Some attempts have been made to more accurately set overdraft limits. The Deposit Score® product from Sheshunoff Management Services, LP is one such product. These products measure various variables in account activity and use the measurements to generate a “score” that can be used to set overdraft limits. While such tools permit more detailed analysis of the historical data at an institution, the relative relationship of the various factors is fixed and may not represent the actual experience of a given bank.

### SUMMARY

In one embodiment, a computer accessible medium stores a plurality of instructions which, when executed: (i) statistically analyze account data corresponding to a plurality of accounts at a financial institution to determine which account data items are most strongly correlated to a charge-off event in an account (and/or a fee revenue event, in some embodiments); (ii) generate one or more factors for one or more equations corresponding to the plurality of accounts, the one or more factors weighting the account data items according to relative correlation to the charge-off event; and (ii) evaluate the one or more equations for the plurality of accounts and establish an account feature for each of the plurality of accounts responsive to the evaluation. For example, the account feature may be the overdraft limit.

In another embodiment, the plurality of instructions, when executed: (i) statistically analyze account data corresponding to a plurality of accounts at a financial institution to identify account data items that strongly correlate to a selected account event; (ii) dynamically generate one or more factors for one or more equations specific to the plurality of accounts based on results of the statistical analysis; and (iii) evaluate the one or more equations to establish a dollar amount of overdraft privilege for each of the plurality of accounts. For example, the selected account event may be a charge-off event and/or a fee revenue event, in various embodiments.

### BRIEF DESCRIPTION OF THE DRAWINGS

The following detailed description makes reference to the accompanying drawings, which are now briefly described.

FIG. 1 is a block diagram of one embodiment of a system including statistical analyzers to generate overdraft limits is shown.

FIG. 2 is a flowchart illustrating operation of one embodiment of a statistical analyzer generating equation weights

FIG. 3 is a flowchart illustrating one embodiment of a block from FIG. 2 in more detail.

FIG. 4 is a flowchart illustrating one embodiment of a statistical analyzer generating overdraft scores.

FIG. 5 is a block diagram of one embodiment of a computer accessible medium.

FIG. 6 is a block diagram of one embodiment of a computer system.

While the invention is susceptible to various modifications and alternative forms, specific embodiments thereof are shown by way of example in the drawings and will herein be described in detail. It should be understood, however, that the drawings and detailed description thereto are not intended to limit the invention to the particular form disclosed, but on the contrary, the intention is to cover all modifications, equivalents and alternatives falling within the spirit and scope of the present invention as defined by the appended claims.

### DETAILED DESCRIPTION OF EMBODIMENTS

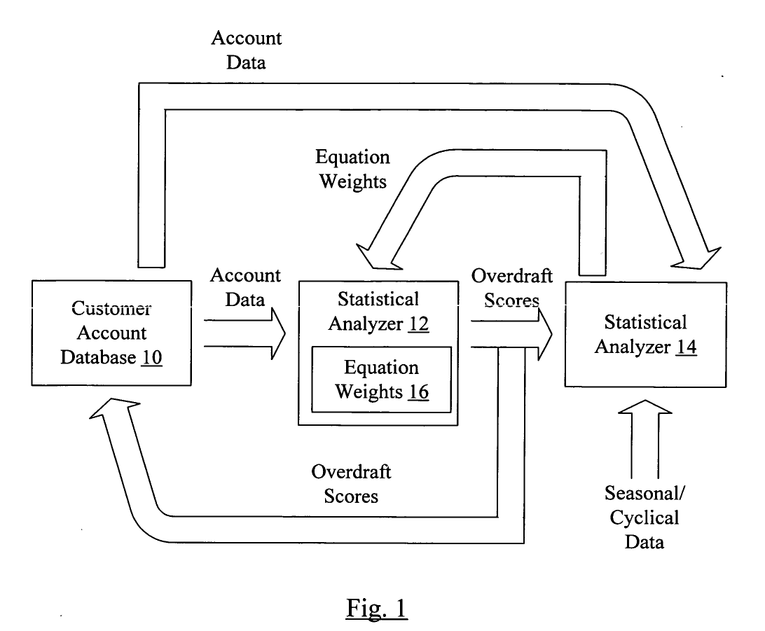

Turning now to FIG. 1, a block diagram of one embodiment of a system for generating overdraft limits for the checking accounts of a financial institution is shown. In the embodiment of FIG. 1, a customer account database 10 and two statistical analyzers 12 and 14 are shown. Various information flowing between the customer account database 10 and the statistical analyzers 12 and 14 are shown via arrows from source to destination.

The customer account database 10 may be maintained by the financial institution or a financial institution service provider, and may be updated as customer transactions are processed. For example, the customer account database 10 may include data identifying each account, as well as account activity data such as deposits, withdrawals, checks cleared, interest earned or charged, fees charged, etc. The account data may also include other information, such as the overdraft score for each account. For brevity, the financial institution will be referred to in this description as a “bank”, but any financial institution may implement the system described herein in various embodiments.

The statistical analyzers 12 and 14 may also be located at the bank. For example, the statistical analyzers 12 and 14 may be installed on a computer or computers at the bank, either the same computer that stores the customer account database 10 or a different computer or computers. Alternatively, one or both of the statistical analyzers 12 and 14 may be located elsewhere, such as at a consultant or other bank service provider. In some embodiments, the account identifiers provided in the account data may not be the actual account numbers used by customers and the bank to process transactions, for security reasons. For example, a hash function or other reversible data manipulation operation may be applied to each account number to generate the account identifier. As long as each account identifier is unique to the corresponding account within the account data, any identifier may be used.

Generally, the statistical analyzers 12 and 14 may be configured to perform statistical analysis on the account data and/or overdraft scores to generate an overdraft score for each account and to update the factors used in the equations to generate the overdraft scores (e.g. equation weights). Specifically, as shown in FIG. 1, the statistical analyzer 12 may receive the account data and may use previously-generated equation weights 16 to generate an overdraft score for each account. The overdraft score may be a dollar amount of overdraft limit for the corresponding account. Alternatively, the overdraft score may be converted to an overdraft limit according to a bank-specific conversion table. The equation weights may include weights for various account data as well as weights for statistical measures generated by the statistical analyzer 12 from the account data (e.g. standard deviation, mean, median, mode, sum of occurrences of a given account data item, number of occurrences of a given account data item, maximum and minimum values for a given account data item, trends in the account activity or data item, etc.). For example, the equation weights may include or be generated from correlation coefficients from logistic regressions and/or chi-squared values.

In one embodiment, each account data item used in the equation to generate the overdraft score is converted to a dollar amount specified by the bank, and the dollar amounts may be weighted according to the equations weights and summed to generate the overdraft score for each account. For example, the bank may assign a dollar amount to a range of value of the account data item, and the dollar amounts assigned for a given account data item may also vary based on the length of time that the account has been open. An account data item, as used herein, may comprise any account data value (provided from the customer account database 10) or a value derived from the account data (e.g. statistical measures derived from the data). In addition, various overrides may be specified. For example, a maximum overdraft limit may be specified by a bank, which may function as a cap to the overdraft limit calculated by the statistical analyzer 12.

The statistical analyzer 14 may receive the overdraft scores generated by the statistical analyzer 12, the account data from the customer account database 10, and optionally seasonal/cyclical data. The statistical analyzer 14 may execute various statistical analysis algorithms on the received information to generate updated equation weights for the statistical analyzer 12. For example, in one embodiment, the statistical analyzer 14 may perform logistic regression and chi-squared analysis to identify which variables are most strongly correlated to charge-off events and/or fee revenue events for each account. Based on the correlation results, the equation weights may be generated to more heavily weight the variables that are more strongly correlated to (or most strongly predictive of) the corresponding event. Relative weights may be generated based on the relative chi-squared values generated for each account data item. For example, the ratio of the chi-squared value for a given account data item to the sum of the chi-squared values for all account data items may specify the relative weight for the given account data item. Account data items that have little or no predictive value (as indicated by the statistical analysis) may be eliminated from the equation (e.g. by setting the corresponding equation weights to zero).

Rather than attempting to define which account data item or items will be used to generate the overdraft score, the system of FIG. 1 allows the actual account activity experienced at the bank and correlation of the activity to selected events to determine the overdraft score. For example, in one embodiment, charge-off events and fee revenue events may be the selected events. Account data items which are strongly predictive of charge-off events and not strongly predictive of fee revenue events may be used to reduce the overdraft score (so that overdraft limits are reduced, reducing or eliminating charge-off events). On the other hand, account data items which are strongly predictive of fee revenue events and which are not strongly predictive of charge-off events may be used to increase the overdraft score (so that overdraft limits are increased, permitting additional items to be paid). Account data items that are strongly predictive of both charge-off events and fee revenue events may be weighted between the other account data items. Thus, the data representing actual account behavior is used to set the limits, in some embodiments, rather than preconceived notions of which variables should control overdraft limits.

Different banks may experience different account activity, and therefore may have different results from the statistical analysis. Accordingly, rather than conforming to account activities that a large number of banks experience (and which may not correlate well to a given bank), the system may more accurately model that bank's customer base and may permit higher profits to be realized for less risk, in some embodiments.

Through study of the statistical data, it can be shown that, of the group of account holders that generate 80% of the fee revenue, 20% of the group is responsible for 80% of the charge-off events. The 20% is at the center of a circle representing the group. The system of FIG. 1 attempts to differentiate the 20% center from the group as a whole, to reduce the charge-offs associated with the center while maximizing the fee revenue from the group, in some embodiments. That is, the system attempts to have a significant (reducing) effect on charge-off events while having only a dilutive effect on fee revenue events.

In this manner, the equations used to generate overdraft scores are dynamically adjusted to reflect actual activity at a given bank. Equations may be adjusted at any level of granularity. For example, the granularity may be the individual account level, the type of account level (e.g. business versus individual), the bank branch level, the geographic area level, etc. Specifically, the equations may be designed, and the equation weights may be generated, to control the overdraft limits to generate maximum fee revenue while minimizing charge-off losses. Since account behavior may differ between individual accounts or type of accounts, different weightings may be appropriate and may be generated using the statistical analysis techniques described herein.

The weights may be relative to the strength of the statistical correlation of the corresponding account data items (as compared to the strength of correlation of other items). In some embodiments, a weight may be negative. For example, a data item that is strongly correlated to a charge-off event and weakly correlated to a fee revenue event may be given a negative weight to reduce the overdraft score and thus the overdraft limit. Alternatively, weights may be made numerically smaller, rather than negative, to reduce the effect of a given account data item on the calculated overdraft score.

The specific account data items that are most strongly correlated to charge-off and fee revenue events may change seasonally, and the historical data used to determine the equation weights may not predict the seasonal changes. Similarly, the account data items that are most strongly correlated to charge-off and fee revenue events may change cyclically (e.g. with business or economic cycles). To capture these variances, the statistical analyzer 14 may receive seasonal/cyclical data that may be used to adjust or override one or more weights. The seasonal/cyclical data may be generated through similar statistical analysis techniques but taking the season/cycle into account.

The frequency at which the statistical analyzers 12 and 14 are executed may vary, and may vary from each other. For example, the statistical analyzer 12 may be executed once per day, to update the overdraft scores for each account. The statistical analyzer 14 may be executed weekly, or monthly, if desired. Alternatively, the statistical analyzer 14 may also be executed daily, to generate new equation weights for the next day's execution of the statistical analyzer 12.

Generally, a statistical analyzer 12 or 14 may include instructions which, when executed on a computer, perform the analyses described herein. The instructions may comprise machine instructions directly executed by one or more processors in the system, or may include higher level instructions that are interpreted (e.g. shell scripts, Java bytecodes, C#, SQL code, stored procedures, etc.) by the computer or compiled (e.g. C or C++ source code) into machine instructions for execution, or any combination of the above. In some embodiments, the statistical analyzers 12 and/or 14 may comprise one or more commercially-available statistical analysis tools along with custom code to interface to the tools to implement the desired analysis. Exemplary commercially-available statistical analysis tools may include Structured Query Language (SQL) Server, Statistical Analysis System (SAS) Enterprise Miner, Minitab, etc.

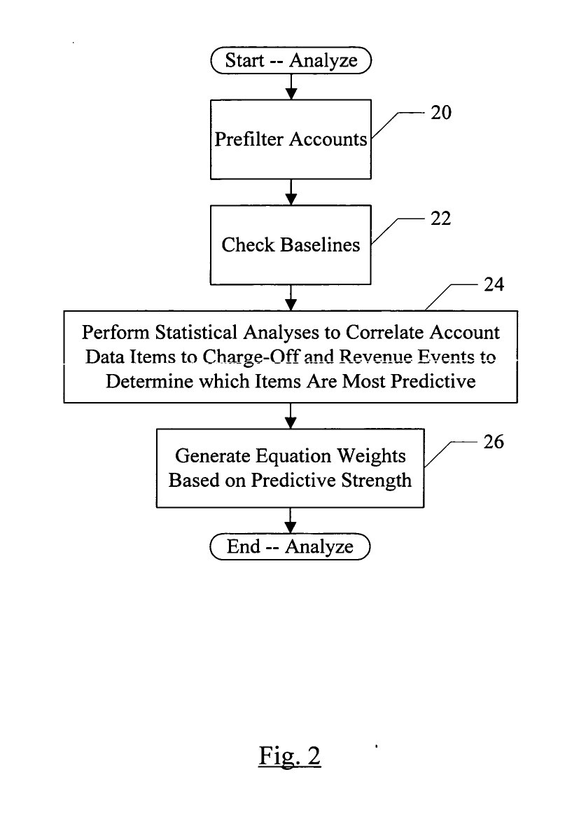

Turning now to FIG. 2, a flowchart is shown illustrating operation of one embodiment of the statistical analyzer 14 to generate the equation weights for the statistical analyzer 12. While the blocks are shown in a particular order for ease of understanding, other orders may be used. The statistical analyzer 14 may comprise instructions which, when executed, implement the operation illustrated in the blocks of FIG. 2.

The statistical analyzer 14 may prefilter the accounts provided from the customer account database 10 (block 20). The prefiltering may be used to eliminate accounts from the analysis if the account data would tend to skew the statistical analysis away from the more predictive factors. For example, accounts that have not been open for long enough may not include enough data for proper analysis. Accounts that had a negative balance prior to implementing the system of FIG. 1 may skew the results, since the overdraft scores were not in use when the overdraft situation occurred in those accounts. Accounts without fee revenue or charge-off events are not predictive of either, and thus need not be analyzed. The last event date is the later of the last (most recent) fee date, the last charge-off date, the last deposit date, or the last score date.

The statistical analyzer 14 may check certain baseline values for the account data to determine if any of the data is erroneous or might otherwise skew the analysis (block 22). In one embodiment, the baseline values may be provided in the account data from the customer account database 10. In other embodiments, the statistical analyzer 14 may generate the baseline values, or some values may be provided from the database and others may be generated by the statistical analyzer 14. In one embodiment, the baseline values may include number of nulls, number of zeros, number of non-null and non-zero, total number, sum, mean, median, and range for each of the following: balances, principal charge-off events and dates, fee charge-off events and dates, account open date, deposit scores and dates, fees and dates, deposits and dates. Some baseline values may not make sense for some data (e.g. the sum, mean, or median of a date) and thus may not be included.

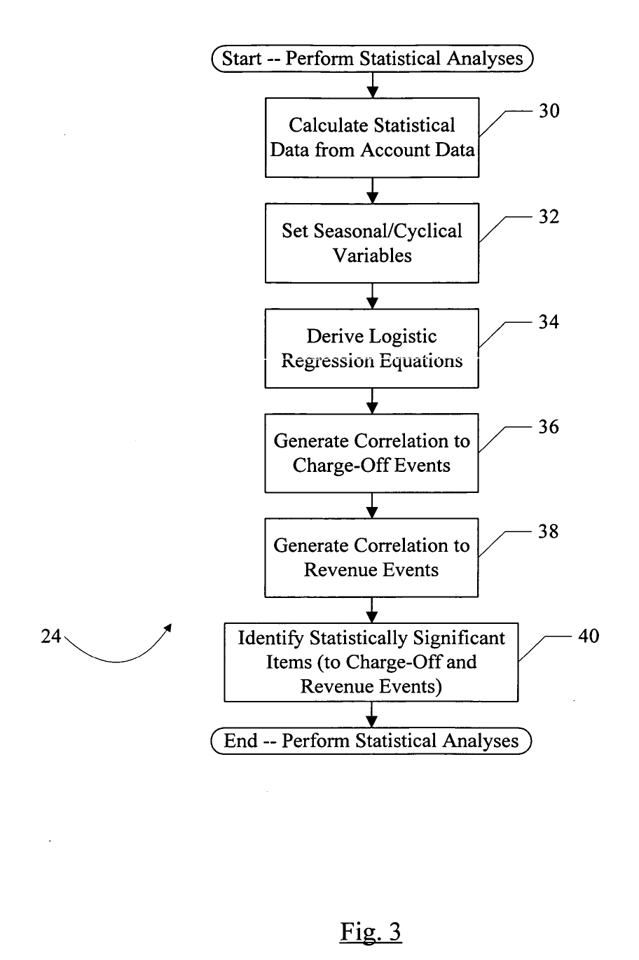

The statistical analyzer 14 may perform statistical analyses to correlate various account data items to charge-off and fee revenue events to determine those account data items that are most predictive of each event (block 24). As mentioned previously, the account data items may include both the account data and data derived from the account data (such as various statistical measures calculated from the account data). Additional details for one embodiment of the analysis are provided in FIG. 3 and described below.

The statistical analyzer 14 may generate equation weights for the various account data items based on the relative predictive strength of the items, and may provide the equation weights to the statistical analyzer 12 for use in subsequent generations of the overdraft scores (block 26).

Turning now to FIG. 3, a flowchart is shown illustrating the statistical analysis performed by one embodiment of the statistical analyzer 14 (block 24 in FIG. 2). While the blocks are shown in a particular order for ease of understanding, other orders may be used. The statistical analyzer 14 may comprise instructions which, when executed, implement the operation illustrated in the blocks of FIG. 3.

The statistical analyzer 14 may generate various statistical data from the account data (block 30). As mentioned previously, some baseline values may be provided by the bank in the account data from the customer account database (in some embodiments). Additional statistics not included in the account data may be generated. For example, various standard deviations, means, modes, medians, etc. may be generated, as desired. Additionally, the statistical analyzer 14 may set various seasonal/cyclical variables responsive to the seasonal/cyclical data provided to the analyzer, if any (block 32). The seasonal/cyclical data may be provided in the form of overrides for certain account data items, additional variables to be included in the equations, or both.

The statistical analyzer 14 may derive logistic regression equations for the account data items (block 34). Logistic regression equations to determine correlations to the charge-off events may be generated, as well as logistic regression equations to determine correlations to the fee revenue events. The statistical analyzer 14 may then perform the logistic regression to generate correlation to charge-off events (block 36) and to fee revenue events (block 38). The correlation may be expressed in terms of correlation coefficients or chi-squared values. The statistical analyzer 14 may then determine the statistically significant items to both charge-off events free revenue events (block 40) to generate the equation weights (block 26, FIG. 2). For example, the statistically significant (most predictive) items may be those with the highest chi-squared values.

It is noted that, while logistic regression correlation coefficients and chi-squared values are used in the present embodiment, other embodiments may use any statistical or mathematical techniques to determine which account data items are most predictive of charge-off events and fee revenue events, either in combination with the above or instead of the above. For example, neural network analysis, time series analysis, sequence clustering analysis, the Naïve Bayes algorithm, association rules, decision trees, linear regression, fuzzy sets, etc. may be used.

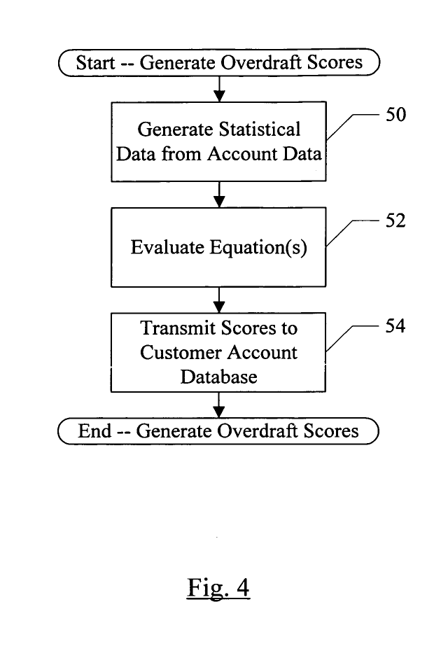

Turning next to FIG. 4, a flowchart is shown illustrating the generation of overdraft scores for one embodiment of the statistical analyzer 12. While the blocks are shown in a particular order for ease of understanding, other orders may be used. The statistical analyzer 12 may comprise instructions which, when executed, implement the operation illustrated in the blocks of FIG. 4.

The statistical analyzer 12 may generate statistical data from the account data for any statistics used in the equation (s) to generate the overdraft score that are not include in the account data, if any (block 50). The statistical analyzer 12 may then evaluate the equation (s) to generate the overdraft score (block 52) for each account, and may transmit the scores to the customer account database 10 for use in processing account transactions (block 54).

In one specific example, the regularity of deposits and the standard deviation of deposit amount were found to be important factors in detecting probability of a charge off event (e.g. a decreasing trend in deposit regularity or increase in the standard deviation of deposit amounts were predictors of charge-off events). Other significant account data items included the length of time that the account has been open and the last fee date or dates in the account.

In one embodiment, the account data provided from the customer account database 10 is categorized into notices, balances, scores, deposits, and charge-off. In one embodiment, each of the above is a file and account identifiers in the files identify which records belong to which account. The notices include the date the account was opened, the amount of principal charge-off (if any), the amount of fees charged-off (if any), and the fee dates and amounts for fees charged to the account. The balances include the balance on each account for various dates. The scores include the overdraft scores calculated for the account and the dates of calculation. The deposits include deposit dates and amounts. The charge-off includes charge-off date and amount.

From the notices, the following statistical data may be generated by the statistical analyzers 12 and 14: first fee date, last fee date, the sum of fees per account, the number of fees per account, and the sum of any fees waved per account. From the scores, the following statistical data may be generated by the statistical analyzers 12 and 14: first score date, last score date, mean score, and number of accounts scored. From the deposits, the following statistical data may be generated by the statistical analyzers 12 and 14: mean deposit, median deposit, standard deviation of deposits, and number of deposits. A last event date may also be calculated as the later of charge-off, deposit, fee, or score dates.

The above notices, scores, deposits, and corresponding statistical data may be merged into a “merge” file, and an “income file” may also be created that includes the fee details for each account. The income file may be merged with the scores, deposits, notices, and balances files, respectively. The merge of the income and scores files may include the overdraft score at 60, 90, 120, 150, and 180 days from the last event date; the score dates for each of the preceding; various statistical indicators of the scores in the date ranges; and the mean score for each of the date ranges. The merge of the income and deposits files may include the number of deposits between 60-90 days, 90-120 days, and 120-180 days from the last event date; statistical indicators of the deposits in the preceding date ranges; and the mean deposit in each date range. The merge of the income and notices files may include the number of fees between 60-90 days, 90-120 days, and 120-180 days from the last event date; statistical indicators of the fees in the preceding date ranges; and the mean fee in each date range. The merge of the income and balances files may include the balance at 60, 90, 120, 150, and 180 days from the last event date; statistical indicators of the balances in the preceding date ranges; the date for each balance; the first and last balance dates for the account; the number of days that each balance existed (to weight the balances); and the mean balance for 60, 90, 120, 150, and 180 days from the last event date. Lastly, a merge of the above merges with the income file may be performed.

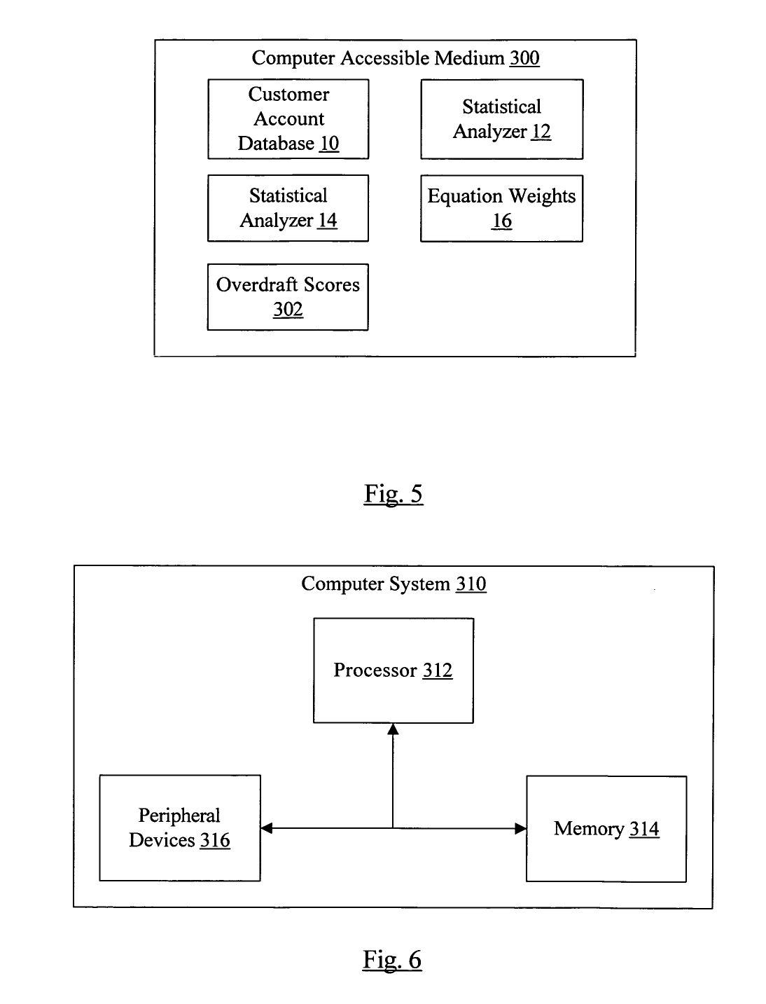

Turning now to FIG. 5, a block diagram of a computer accessible medium 300 is shown. Generally speaking, a computer accessible medium may include any media accessible by a computer during use to provide instructions and/or data to the computer. For example, a computer accessible medium may include storage media. Storage media may include magnetic or optical media, e.g., disk (fixed or removable), tape, CD-ROM, or DVD-ROM, CD-R, CD-RW, DVD-R, DVD-RW. Storage media may also include volatile or non-volatile memory media such as RAM (e.g. synchronous dynamic RAM (SDRAM), Rambus DRAM (RDRAM), static RAM (SRAM), etc.), ROM, or Flash memory. Storage media may include non-volatile memory (e.g. Flash memory) accessible via a peripheral interface such as the Universal Serial Bus (USB) interface in a solid state disk form factor, etc. The computer accessible medium may include microelectromechanical systems (MEMS), as well as media accessible via transmission media or signals such as electrical, electromagnetic, or digital signals, conveyed via a communication medium such as a network and/or a wireless link. The computer accessible medium 300 in FIG. 5 may store one or more of the customer account database 10, the statistical analyzer 12, the statistical analyzer 14, the equation weights 16, and/or the overdraft scores 302. The various software may comprise instructions which, when executed, implement the operation described herein for the respective software. Generally, the computer accessible medium 300 may store any set of instructions which, when executed, implement a portion or all of the flowcharts shown in one or more of FIGS. 2, 3, and 4.

FIG. 6 is a block diagram of one embodiment of an exemplary computer system 310. In the embodiment of FIG. 6 the computer system 310 includes a processor 312, a memory 314, and various peripheral devices 316. The processor 312 is coupled to the memory 314 and the peripheral devices 316.

The processor 312 is configured to execute instructions, including the instructions in the software described herein, in some embodiments. In various embodiments, the processor 312 may implement any desired instruction set (e.g. Intel Architecture-32 (IA-32, also known as x86), IA-32 with 64 bit extensions, x86-64, PowerPC, Sparc, MIPS, ARM, IA-64, etc.). In some embodiments, the computer system 310 may include more than one processor.

The processor 312 may be coupled to the memory 314 and the peripheral devices 316 in any desired fashion. For example, in some embodiments, the processor 312 may be coupled to the memory 314 and/or the peripheral devices 316 via various interconnect. Alternatively or in addition, one or more bridge chips may be used to couple the processor 312, the memory 314, and the peripheral devices 316, creating multiple connections between these components.

The memory 314 may comprise any type of memory system. For example, the memory 314 may comprise DRAM, and more particularly double data rate (DDR) SDRAM, RDRAM, etc. A memory controller may be included to interface to the memory 314, and/or the processor 312 may include a memory controller. The memory 314 may store the instructions to be executed by the processor 312 during use (including the instructions implementing the software described herein), data to be operated upon by the processor 312 during use, etc.

Peripheral devices 316 may represent any sort of hardware devices that may be included in the computer system 310 or coupled thereto (e.g. storage devices, optionally including a computer accessible medium 300, other input/output (I/O) devices such as video hardware, audio hardware, user interface devices, networking hardware, etc.). In some embodiments, multiple computer systems may be used in a cluster.

Numerous variations and modifications will become apparent to those skilled in the art once the above disclosure is fully appreciated. It is intended that the following claims be interpreted to embrace all such variations and modifications.

What is claimed is:

1. A computer accessible medium storing a plurality of instructions which, when executed:
statistically analyze account data corresponding to a plurality of accounts at a financial institution to determine which account data items are most strongly correlated to a charge-off event in an account;
generate one or more factors for one or more equations corresponding to the plurality of accounts, the one or more factors weighting the account data items according to relative correlation to the charge-off event; and
evaluate the one or more equations for the plurality of accounts and establish an account feature for each of the plurality of accounts responsive to the evaluation.

2. The computer accessible medium as recited in claim 1 wherein the account data comprises account activity data.

3. The computer accessible medium as recited in claim 2 wherein the account data further comprises additional data derived from the account activity data, wherein the plurality of instructions, when executed, derive the additional data.

4. The computer accessible medium as recited in claim 1 wherein the account feature comprises a dollar amount of overdraft privilege provided for the account.

5. The computer accessible medium as recited in claim 4 wherein the one or more equations are designed to reduce the dollar amount if the probability of the charge-off event increases.

6. The computer accessible medium as recited in claim 4 wherein the one or more equations are designed to increase the dollar amount if the probability of the charge-off event decreases.

7. The computer accessible medium as recited in claim 1 wherein the correlation is measured by logistic regression and chi-squared.

8. The computer accessible medium as recited in claim 1 wherein the plurality of instructions, when executed, statistically analyze the account data to determine which account data items are most strongly correlated to a fee revenue event in an account.

9. The computer accessible medium as recited in claim 8 wherein the one or more equations attempt to control the account feature to increase fee revenue and to decrease charge-off expense.

10. A computer system comprising:
the computer accessible medium as recited in claim 1; and
at least one processor configured to execute the plurality of instructions.

11. A computer accessible medium storing a plurality of instructions which, when executed:
statistically analyze account data corresponding to a plurality of accounts at a financial institution to identify account data items that strongly correlate to at least one selected account event;
dynamically generate one or more factors for one or more equations specific to the plurality of accounts based on results of the statistical analysis; and
evaluate the one or more equations to establish a dollar amount of overdraft privilege for each of the plurality of accounts.

12. The computer accessible medium as recited in claim 11 wherein the one or more equations attempt to increase a probability of fee revenue and decrease a probability of the selected account event.

13. The computer accessible medium as recited in claim 12 wherein the selected account event is a charge off event.

14. The computer accessible medium as recited in claim 12 wherein the selected account event is a fee revenue event.

15. A method comprising:
statistically analyzing account data corresponding to a plurality of accounts at a financial institution to determine which account data items are most strongly correlated to a charge-off event and which account data items are most strongly correlated to a fee revenue event in an account; and
generating one or more factors for one or more equations corresponding to the plurality of accounts, the one or more factors weighting the account data items according to relative correlation to the charge-off event or the fee revenue event.

16. The method as recited in claim 15 further comprising evaluation the one or more equations for the plurality of accounts and establish an account feature for each of the plurality of accounts responsive to the evaluating.

17. The method as recited in claim 16 wherein the account feature is a dollar amount of an overdraft privilege.

18. The method as recited in claim 15 further comprising statistically analyze the account data to determine which account data items are most strongly correlated to a fee revenue event in an account.

19. The method as recited in claim 18 wherein the one or more factors combine results of the statistical analyzings.

20. The method as recited in claim 19 wherein the one or more equations attempt to control the account feature to increase fee revenue and to decrease charge-off expense.
